(19) United States
(12) Patent Application Publication
(10) Pub. No.: US 2014/0295235 A1
(43) Pub. Date: Oct. 2, 2014

(54) BATTERY MODULE

(71) Applicant: SAMSUNG SDI CO., LTD., Yongin-si (KR)

(72) Inventor: Hyun-Min Jung, Yongin-si (KR)

(73) Assignee: SAMSUNG SDI CO., LTD., Yongin-si (KR)

(21) Appl. No.: 14/183,483

(22) Filed: Feb. 18, 2014

Related U.S. Application Data
(60) Provisional application No. 61/806,745, filed on Mar. 29, 2013.

(51) Int. Cl. H01M 2/10

(52) U.S. Cl. CPC H01M 2/1077
USPC 429/99

(57) ABSTRACT

A battery module including a plurality of battery cells; and a housing accommodating the battery cells, the housing comprising a side plate, a bottom plate, and a bending portion between the side plate and the bottom plate, wherein the bending portion is configured to bias the side plate and the bottom plate toward the battery cells.

### CROSS-REFERENCE TO RELATED APPLICATION

This application claims priority to and the benefit of U.S. Provisional Application No. 61/806,745, filed on Mar. 29, 2013 in the U.S. Patent and Trademark Office, the entire content of which is incorporated herein by reference.

### BACKGROUND

1. Field

An aspect of the present invention relates to a battery module.

2. Description of the Related Art

A high-power battery module using a non-aqueous electrolyte with high energy density has recently been developed. The high-power battery module is configured as a large-capacity battery module manufactured by connecting a plurality of battery cells in series to be used for driving devices, e.g., motors of electric vehicles and the like, which require high power.

The battery module includes a plurality of battery cells based on a specified output voltage and current. The battery module also includes a frame for firmly fixing the battery cells. When a tolerance with which the width of the battery cells is greater or smaller than that of the frame, the battery cells may not be able to be firmly fixed by the frame.

### SUMMARY

Embodiments provide a battery module in which a frame is adhered closely to battery cells even when there is a tolerance with which the width of the battery cells is greater or smaller than that of the frame, so that the battery cells can be firmly fixed by the frame.

According to an aspect of the present invention, there is provided a battery module, including: one or more battery cells arranged in one direction; a pair of side plates disposed to come in surface contact with sides of the battery cells; and a bottom plate formed to extend from the pair of side plates, and facing bottoms of the battery cells, wherein a bending portion having a sectional shape convex to an outside of the battery module so that the side plate is moved in the side direction of the battery cell or in the opposite direction of the side of the battery cell is formed in a region where the side plate and the bottom plate are connected to each other.

The convex sectional shape may be a round shape.

When the length of the battery cell in the width direction is smaller than the interval between the pair of side plates, the round shape may be changed by a force applied in the side direction of the battery cell from the outside, and the side plate may be horizontally moved in the side direction of the battery cell.

When the length of the battery cell in the width direction is greater than the interval between the pair of side plates, the round shape may be changed by a force applied in the opposite direction to the side of the battery cell from the outside, and the side plate may be horizontally moved in the opposite direction to the side of the battery cell.

The bending portion may include a first extending portion extended from the bottom plate, and a second extending portion extended diagonally with respect to the side direction of the battery cell from the first extending portion.

When the length of the battery cell in the width direction is smaller than the interval between the pair of side plates, the angle formed between the first and second extending portions may be decreased by the force applied in the side direction of the battery cell from the outside, and the side plate may be horizontally moved in the side direction of the battery cell.

When the length of the battery cell in the width direction is greater than the interval between the pair of side plates, the angle formed between the first and second extending portions may be increased by the force applied in the side direction of the battery cell from the outside, and the side plate may be horizontally moved in the opposite direction to the side of the battery cell.

The side plate may be formed to extend in the direction parallel with the side of the battery cell from the second extending portion.

The bending portion may further include a cut-away groove formed between the first and second extending portions.

The battery module may further include a pair of end plates respectively coming in surface contact with the outermost battery cells among the battery cells, and a top cover covering tops of the battery cells.

One end of the side plate may be fastened to one end of the end plate through laser welding.

The side plate may include at least one first fastening portion fastened to the top cover, and the bottom plate may include at least one first fastening portion fastened to the end plate.

The top cover may include at least one first fastening portion fastened to the side plate, and at least one second fastening portion fastened to the end plate.

The end plate may include at least one first fastening portion fastened to the top cover, and at least one second fastening portion fastened to the bottom plate.

The first fastening portion of the side plate and the first fastening portion of the top cover, the second fastening portion of the top cover and the first fastening portion of the end plate, or the second fastening portion of the end plate and the first fastening portion of the bottom plate may be fastened to each other by the medium of a fastening member or through laser welding.

The fastening member may be a bolt-nut or stud.

The side plate may have at least one opening formed therein.

According to the present invention it is possible to a battery module capable of absorbing a width tolerance.

Accordingly, a frame can come in surface contact with battery cells, regardless of the size of the battery cells in the width direction, thereby firmly fixing the battery cells.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view schematically showing a battery module according to an embodiment of the present invention.

FIG. 2 is an exploded perspective view of FIG. 1.

FIGS. 3A to 3C are enlarged sectional views showing region A of FIG. 1.

FIGS. 4A and 4B are partial enlarged sectional views showing a front lower portion of the battery module when no bending portion is formed.

FIGS. 5A to 5C are partial enlarged sectional views showing a front lower portion of a battery module according to another embodiment of the present invention.

FIG. 6 is a partial enlarged sectional view showing a front lower portion of a battery module according to still another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements located therebetween. Also, when an element is referred to as being “connected to” another element, it can be directly connected to the another element or be indirectly connected to the another element with one or more intervening elements located therebetween. Hereinafter, like reference numerals refer to like elements.

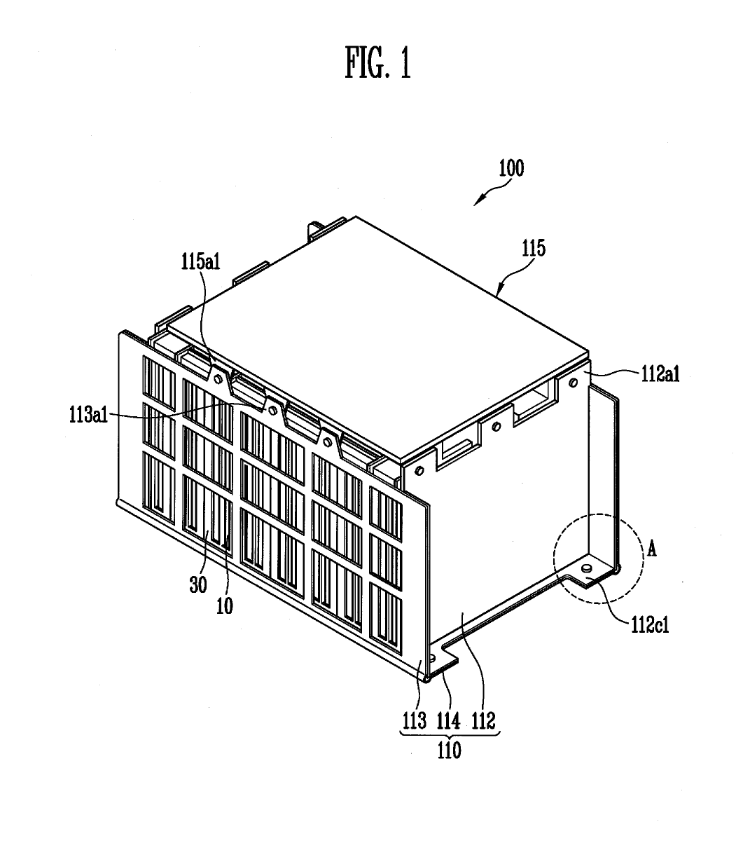

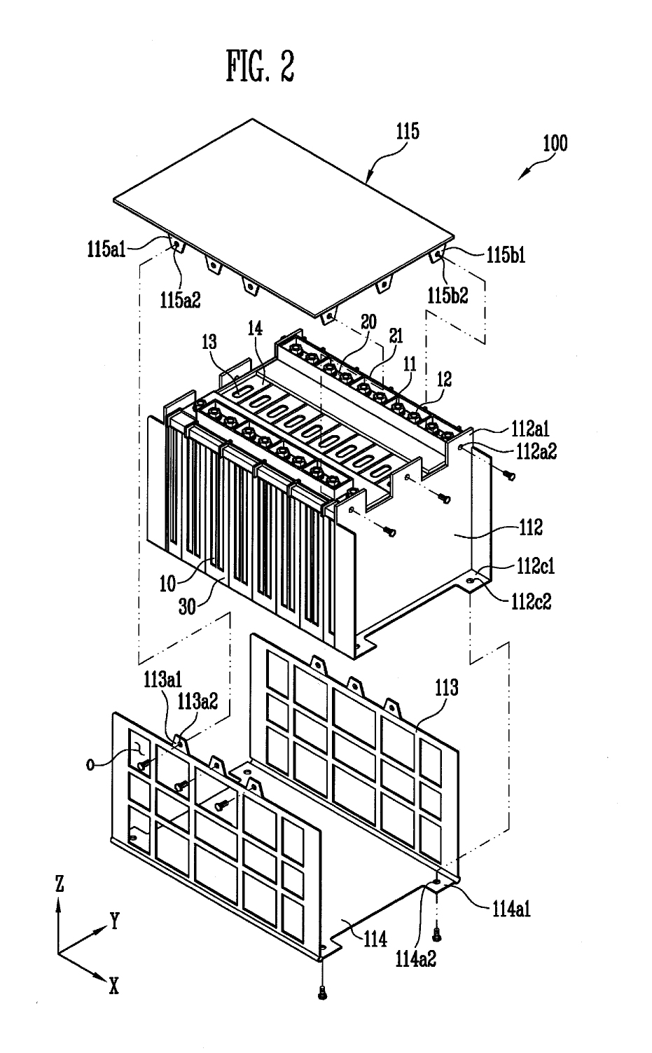

FIG. 1 is a perspective view schematically showing a battery module according to an embodiment of the present invention. FIG. 2 is an exploded perspective view of FIG. 1.

The battery module 100 according to this embodiment includes a plurality of battery cells 10 arranged in one direction and each having electrode terminals 11 and 12. In this case, the battery cells 10 are arranged so that wide surfaces of adjacent battery cells 10 face each other.

Each of the battery cells 10 constituting the battery module 100 may be manufactured by accommodating an electrode assembly and an electrolyte in a battery case and then sealing the battery case in which the electrode assembly is accommodated using a cap plate 14. In one embodiment, the electrode assembly includes a positive electrode plate and a negative electrode plate and a separator located between these electrode plates. The cap plate 14 may be provided with electrode terminals protruded to the outside thereof. The electrode terminals may be positive and negative electrode terminals 11 and 12 respectively connected to the positive and negative electrode plates. The positive and negative electrode plates may generate electrochemical energy by reacting with the electrolyte. Accordingly, the generated energy is transferred to the outside of the battery cell 10 through the positive and negative electrode terminals 11 and 12. A vent is provided in the cap plate 14 between the positive and negative electrode terminals 11 and 12, to serve as a passage through which gas is exhausted to the outside of the battery cell 10.

In this embodiment, a case where the battery cell 10 is a prismatic secondary battery will be described as an example. However, the present invention is not limited thereto and may be applied to various types of batteries including a lithium polymer battery, a cylindrical battery, and the like.

A housing member 110 according to this embodiment includes a pair of end plates 112 respectively coming in surface contact with the outermost battery cells 10 among the plurality of battery cells 10, a pair of side plates 113 located between the pair of end plates 112, and coming in surface contact with surfaces of the battery cells 10, and a bottom plate 114 facing bottoms of the battery cells 10. In one embodiment, the bottom plate 114 may be extended in the vertical direction from the pair of side plates 113 so as to be integrally formed with the side plates 113.

The side plate 113 has at least one first fastening portion 113a1 fastened to a top cover 115, and a first fastening opening 113a2 is formed in the first fastening portion 113a of the side plate 113.

The bottom plate 114 has at least one fastening portion 114a1 fastened to the end plate 112, and a fastening opening 114a2 is formed in the fastening portion 114a1 of the bottom plate 114.

The top cover 115 has at least one first fastening portion 115a1 fastened to the side plate 113 and at least one second fastening portion 115b1 fastened to the end plate 112. First and second fastening openings 115a2 and 115b2 are respectively formed in the first and second fastening portions 115a1 and 115b1 of the top cover 115.

The end plate 112 has at least one first fastening portion 112a1 fastened to the top cover 115 and at least one second fastening portion 112c1 fastened to the bottom plate 114. First and second fastening openings 112a2 and 112c2 are respectively formed in the first and second fastening portions 112a1 and 112c1 of the end plate 112.

The first and second end plates 112 are oriented to come in surface contact with the respective outermost battery cells 10, thereby pressurizing the plurality of battery cells 10 to the inside thereof, i.e., compressing the battery cells together. The side plate 113 connects the first and second end plates 112 to each other. One end of the side plate 113 is fastened to the first end plate 112, and the other end of the side plate 113 is fastened to the second end plate 112. In one embodiment, the first and second end plates 112 may be fasted to the side plate 113 through laser welding.

The side plates 113 provide a space in which the plurality of battery cells 10 can be aligned by connecting the first and second end plates 112 to each other, and simultaneously support both sides of the battery cells 10. Referring to FIG. 2, it has been described in this embodiment that the side plates 113 support both the sides of the battery cells 10 and have openings 0 for a coolant flow path, which are formed therein. However, the shape and the like of the side plate 113 may be freely modified according to the design of the battery module 100. The battery cells 10 are fixed in the space defined by the first and second end plates 112 and the side plates 113 so as not to be easily moved by an external impact.

A barrier 30 may be located between adjacent battery cells 10. A spacer is provided in each barrier 30 to space the plurality of adjacent battery cells 10 from each other and to form a space between the battery cells 10. Accordingly, it is possible to provide the flow path of a coolant for cooling the battery cells 10.

The battery module 100 may further include a bus-bar 20 connecting the positive and negative electrodes 11 and 12 of the adjacent battery cells 10, and a shielding wall 21 surrounding adjacent bus-bars 20.

The shielding wall 21 may be provided to partition a plurality of bus-bars 20 electrically connecting the electrode terminals 11 and 12 of the adjacent battery cells 10. Thus, it is possible to prevent a short circuit between adjacent bus-bars 20 and to prevent a short circuit caused by an electric conductor made of metal such as a bolt-nut, which is a material used in the battery module 100.

In this embodiment, the fastening portion 113a1, 114a1, 115a1, 115b1, 112a1 or 112c1 and the fastening opening 113a2, 114a2, 115a2, 115b2, 112a2 or 112c2 may be fastened to each other by a fastening member such as a bolt-nut or stud. When necessary, the fastening portion and the fastening opening may be fastened to each other through welding.

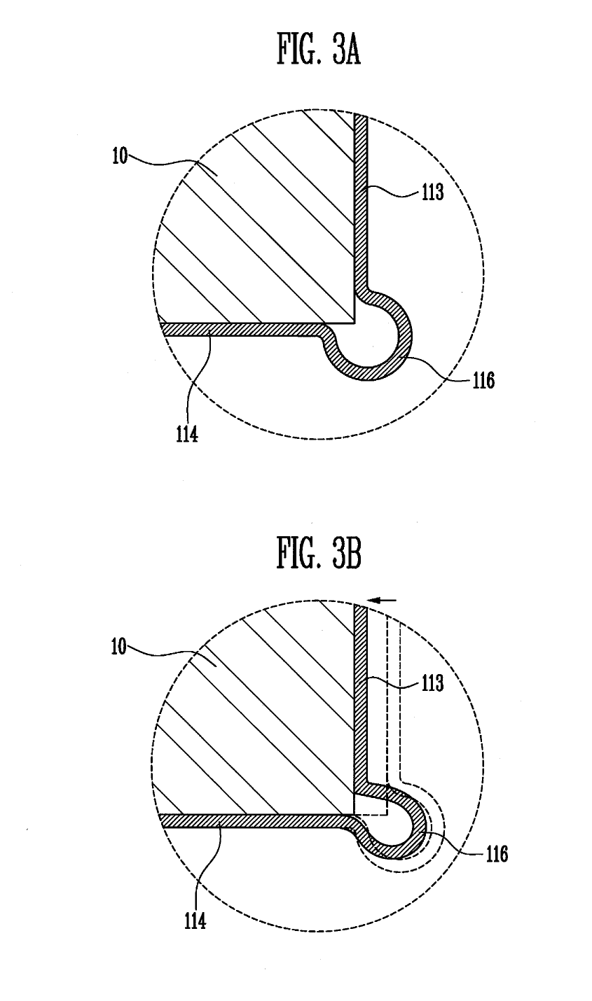

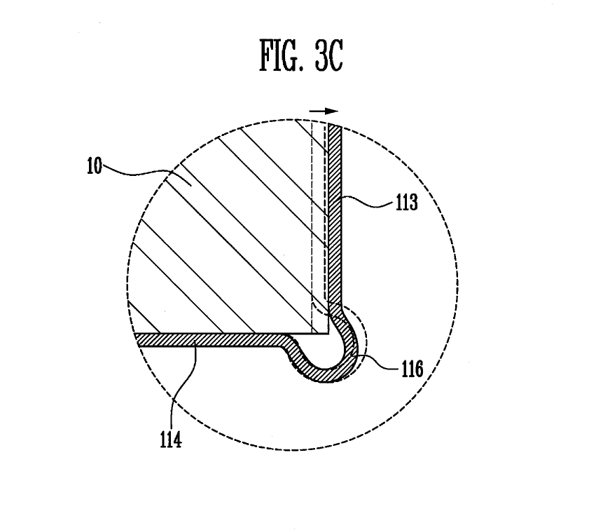

FIGS. 3A to 3C are enlarged sectional views showing region A of FIG. 1.

Referring to FIGS. 3A to 3C, a bending portion 116 is formed in a region where the side plate 113 and the bottom plate 114 are connected to each other. The bending portion 116 has a sectional shape protruding outward so that the side plate 113 can be moved in a side direction of the battery cell 10 or in the opposite direction thereto.

According to one embodiment, the sectional shape of the bending portion 116 may be a round shape.

For example, in a case where the length of the battery cell 10 in the width direction is smaller than the interval between the pair of side plates 113, the side plate 113 may be horizontally moved in a side direction of the battery cell 10 through a change in the bending portion 116 as shown in FIG. 3B. That is, the side plate 113 is moved in the side direction of the battery cell 10 by a force applied from the outside, thereby coming in surface contact with the side of the battery cell 10.

In a case where the length of the battery cell 10 in the width direction is greater than the interval between the pair of side plates 113, the side plate 113 may be moved in the opposite direction to the side direction of the battery cell 10 through a change in the bending portion 116 as shown in FIG. 3C. That is, the battery cell 10 is inserted into a space formed between the side plate 113 and the bottom plate 114 through the horizontal movement of the side plate 113, thereby assembling the battery pack. When the battery cell 10 is inserted into the space formed between the side plate 113 and the bottom plate 114, the side plate 113 comes in surface contact with the side of the battery cell 10.

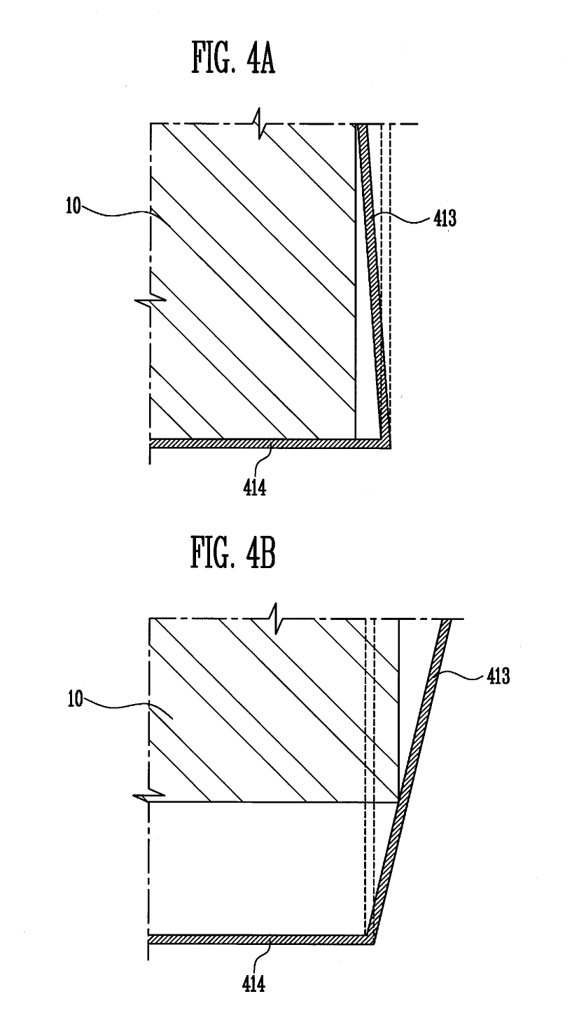

FIGS. 4A and 4B are partial enlarged sectional views showing a front lower portion of the battery module when no bending portion is formed.

In a case where no bending portion is formed, a side plate 413 may be formed to protrude in the vertical direction from a bottom plate 414.

In a case where the length of the battery cell 10 in the width direction is smaller than the interval between the pair of side plates 413, a void occurs between the side plate 413 and a side of the battery cell 10 as shown in FIG. 4A. Although the side plate 413 is moved in the side direction of the battery cell 10, the side plate 413 may not come into surface contact with the side of the battery cell 10.

When the length of the battery cell 10 in the width direction is greater than the interval between the pair of side plates 413, the battery cell 10 may not be able to be assembled in a space formed between the side plate 413 and the bottom plate 414 as shown in FIG. 4B.

Accordingly, in the battery module according to this embodiment, the bending portion 116 is formed in the region where the side plate 113 and the bottom plate 114 are connected to each other as described in FIG. 3, so that the side of the battery cell 10 can come in surface contact with the side plate 113 even if the width direction of the battery cell 10 is not constant.

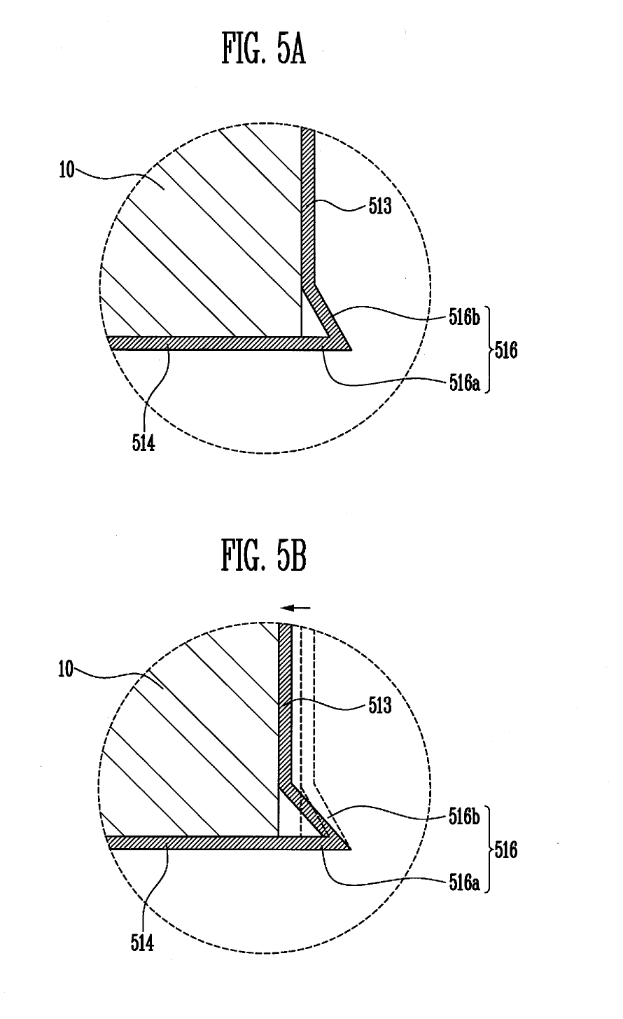

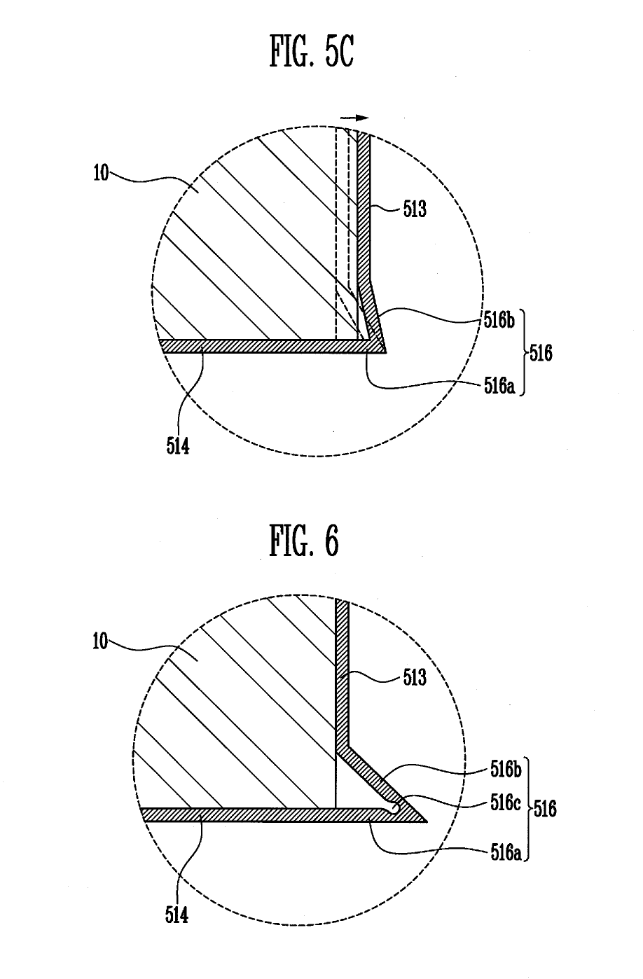

FIGS. 5A to 5C are partial enlarged sectional views showing a front lower portion of a battery module according to another embodiment of the present invention.

Referring to FIG. 5A, a bending portion 516 having a sectional shape convex to the outside of the battery module is formed in the region where a side plate 513 and a bottom plate 514 are connected to each other.

The bending portion 516 may include a first extending portion 516a extended from the bottom plate 514, and a second extending portion 516b extended diagonally with respect to the side direction of the battery cell 10 from the first extending portion 516a.

In this case, the side plates 513 may be formed to extend in the direction parallel with the side of the battery cell 10 from the second extending portion 516b.

Although it has been illustrated in FIG. 5A that the first extending portion 516a is formed to extend in the direction parallel with the bottom plate 514, the first extending portion 516a may be formed to extend while having an inclination of 90 degrees or less.

For example, in a case where the length of the battery cell 10 in the width direction is smaller than the interval between the pair of side plates 513, the angle formed between the first and second extending portions 516a and 516b may be decreased through a force applied in the side direction of the battery cell 10 from the outside as shown in FIG. 5B. Accordingly, the side plate 513 is horizontally moved in the side direction of the battery cell 10, so that the side plate 513 can come in surface contact with the side of the battery cell 10.

In a case where the length of the battery cell 10 in the width direction is greater than the interval between the pair of side plates 513, the angle formed between the first and second extending portions 516a and 516b can be increased through a force applied in the opposite direction to the side of the battery cell 10 from the outside as shown in 5C. In this case, the side plate 513 is horizontally moved in the opposite direction to the side of the battery cell 10. Thus, in a case where the length of the battery cell 10 in the width direction is greater than the interval between the pair of side plates 513, the battery cell 10 can be inserted into a space formed between the side plate 513 and the bottom plate 514, and the side plate 513 can come in surface contact with the side of the battery cell 10 in the insertion of the battery cell 10.

FIG. 6 is a partial enlarged sectional view showing a front lower portion of a battery module according to still another embodiment of the present invention.

Referring to FIG. 6, components in this embodiment except a bending portion 516 are identical to those in the embodiment shown in FIG. 5. Therefore, like components are designated by like reference numerals, and their detailed descriptions will be omitted.

As shown in FIG. 6, the bending portion 516 may include a first extending portion 516a extended from the bottom plate 514, a second extending portion 516b extended diagonally with respect to the side direction of the battery cell 10 from the first extending portion 516a, and a cut-away groove 516c formed between the first and second extending portions 516a and 516b.

Here, the cut-away groove 516c may perform a function of facilitating a change in the second extending portion 516b in the lateral direction.

As described above, the bending portion 116 or 516 enabling the side plate 113 or 513 to be moved is formed in the region where the side plate 113 or 513 and the bottom plate 114 or 514 are connected to each other, so that the side plate 113 or 513 can come in surface contact with the side of the battery cell 10 even when there occurs a tolerance between the length of the battery cell 10 in the width direction and the interval between the pair of side plates 113 or 513. In other words, a frame can come in surface contact with the battery cell, regardless of the length of the battery cell in the width direction, so that the battery cells can be firmly fixed by the frame.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery module comprising:
a plurality of battery cells; and
a housing accommodating the battery cells, the housing comprising a side plate, a bottom plate, and a bending portion between the side plate and the bottom plate, wherein the bending portion is configured to bias the side plate and the bottom plate toward the battery cells.

2. The battery module of claim 1, wherein the bending portion is rounded.

3. The battery module of claim 1, wherein the bending portion protrudes outwardly from at least one of the side plate or the bottom plate.

4. The battery module of claim 1, wherein the bending portion protrudes outwardly from both the side plate and the bottom plate.

5. The battery module of claim 1, wherein at least a portion of the bending portion is spaced from each of the battery cells.

6. The battery module of claim 1, wherein the bending portion comprises a first extending portion extending from the bottom plate and a second extending portion extending from the side plate.

7. The battery module of claim 6, wherein the second extending portion extends at an angle with respect to the side plate.

8. The battery module of claim 6, wherein the bending portion further includes a groove.

9. The battery module of claim 8, wherein the groove is between the first extending portion and the second extending portion.

10. The battery module of claim 1, wherein the bending portion is flexible and configured to change shape depending on a size of each of the battery cells.

11. The battery module of claim 1, further comprising a pair of end plates, each of the end plates located at one end of the battery cells, wherein the end plates are coupled to at least one of the bottom plate or side plate.

12. The battery module of claim 11, wherein the bottom plate has a fastening portion having a fastening opening and wherein the bottom plate is coupled to each of the end plates.

13. The battery module of claim 1, wherein the side plate, the bottom plate, and the bending portion are integral as a single component.

14. The battery module of claim 1, wherein the bending portion extends along an entire length of the side plate.

15. The battery module of claim 1, further comprising a top cover coupled to the side plate.

16. The battery module of claim 1, wherein the side plate extends substantially parallel to a side of each of the battery cells.

17. A battery module comprising:
a plurality of battery cells; and
a housing accommodating the battery cells, the housing comprising a side plate, a bottom plate, and a bending portion between the side plate and the bottom plate, wherein the bending portion protrudes outwardly from at least one of the side plate or the bottom plate.

18. The battery module of claim 17, wherein the bending portion is rounded.

19. The battery module of claim 17, wherein the bending portion comprises a first extending portion extending from the bottom plate and a second extending portion extending from the side plate.

20. The battery module of claim 17, wherein the side plate, the bottom plate, and the bending portion are integral as a single component.
